(19) United States
(12) Patent Application Publication
(10) Pub. No.: US 2020/0368564 A1
(43) Pub. Date: Nov. 26, 2020

(54) FIRE PROTECTIVE COVER FOR PROTECTING A STRUCTURE

(71) Applicant: URBNTEK LLC, San Diego, CA (US)

(72) Inventor: Charles Castelo, San Diego, CA (US)

(73) Assignee: URBNTEK LLC, San Diego, CA (US)

(21) Appl. No.: 16/870,786

(22) Filed: May 8, 2020

Related U.S. Application Data
(60) Provisional application No. 62/844,891, filed on May 8, 2019.

(51) Int. Cl. A62C 2/10; A62C 3/02

(52) U.S. Cl. CPC A62C 2/10; A62C 3/002; A62C 3/0257

(57) ABSTRACT

A system for protecting a structure in imminent threat of a fire hazard, the system includes a fire protective cover formed from a plurality of side-cover portions and a plurality of roof-cover portions, each of the side and roof -cover portions being adapted to attach to one or more eaves of the structure via a plurality of attachment elements, for example, clamps and the like. In addition, an optional cable may be engaged around a periphery of the structure and secured for holding the side-cover portions against side sections of the structure. A method is described for installing the system and fire protective cover thereof.

### CROSS-REFERENCE TO RELATED APPLICATIONS

This application claims benefit of priority with U.S. Provisional Application Ser. No. 62/844,891, filed May 8, 2019; the entire contents of which are hereby incorporated by reference.

### BACKGROUND

### Field of the Invention

This invention relates to articles of manufacture for fire protection; and more particularly, to a system including a fire protective cover for protecting a structure in imminent threat of a fire hazard, and a method for installing the system and fire protective cover.

### Description of the Related Art

Fire protective covers have been proposed for protecting structures in imminent threat of a fire hazard; however, no such covers have been successfully implemented in the marketplace, mostly due to high cost of materials and cumbersome installation requirements.

Fore example, a covering for protecting a structure from fire, as well as several related prior art embodiments, are each disclosed by DOR-EL in US 2017/0021208, published Jan. 26, 2017; the entire contents of which are hereby incorporated by reference. A review of the DOR-EL disclosure presents several problems with the prior art fire protective coverings, namely, elaborate high-cost systems, cumbersome installation and maintenance, among other things.

It may not make sense to permanently install a fire protective cover on homes. In such embodiments, the system will likely oxidize in the sun over the years and become dysfunctional by the time it is needed. Otherwise, ongoing maintenance, testing, and other burdensome and costly requirements would be imposed.

There is an ongoing and heartfelt need to provide a solution for protecting a structure from an imminent threat of fire hazard. Ideally, the solution provides a temporary protection of a structure in danger of imminent threat of a fire hazard, which can be quickly erected and removed when needed.

### SUMMARY

A system for protecting a structure in imminent threat of a fire hazard is disclosed, the system including a fire protective cover formed from a plurality of side-cover portions and a plurality of roof-cover portions, each of the side and roof-cover portions being adapted to attach to one or more eaves of the structure via a plurality of attachment elements, for example, clamps and the like.

In addition, an optional cable may be engaged around a periphery of the structure and secured for holding the side-cover portions against side sections of the structure.

A method is described for installing the system and fire protective cover thereof.

### BRIEF DESCRIPTION OF THE DRAWINGS

These and other features of the invention will become apparent to one having the ordinary level of skill in the art upon a thorough review of the following details and descriptions, particularly when reviewed in conjunction with the drawings, wherein:

FIG. 1A shows a structure, from a front view thereof, having a roof with four roof-sections and corresponding side-sections extending about a periphery of the structure.

FIG. 1B shows the structure, from a rear view thereof, having a roof with four roof-sections and corresponding side-sections extending about a periphery of the structure.

FIG. 1C shows the structure, from a top view thereof, having a roof with four roof-sections.

FIG. 2A shows a first step for covering the structure with a fire protective cover.

FIG. 2B shows a second step for covering the structure with the fire protective cover.

FIG. 2C shows a third step for covering the structure with the fire protective cover.

FIG. 2D shows a fourth step for covering the structure with the fire protective cover.

FIG. 2E shows a fifth step for covering the structure with the fire protective cover.

FIG. 2F shows a sixth step for covering the structure with the fire protective cover.

FIG. 2G shows a seventh step for covering the structure with the fire protective cover.

FIG. 2H shows an eighth step for covering the structure with the fire protective cover.

FIG. 2I shows the structure with a fire protective cover completely installed and secured with an optional cable.

FIG. 3 shows a system comprising a plurality of side-cover portions, a plurality of roof-cover portions, a plurality of attachment elements, and an optional cable and cable-mating element.

### DETAILED DESCRIPTION OF EMBODIMENTS

For purposes of explanation and not limitation, details and descriptions of certain preferred embodiments are hereinafter provided such that one having ordinary skill in the art may be enabled to make and use the invention. These details and descriptions are representative only of certain preferred embodiments, however, and a myriad of other embodiments which will not be expressly described will be readily understood by one having skill in the art upon a thorough review of the instant disclosure. Accordingly, any reviewer of the instant disclosure should interpret the scope of the invention only by the claims, as such scope is not intended to be limited by the embodiments described and illustrated herein.

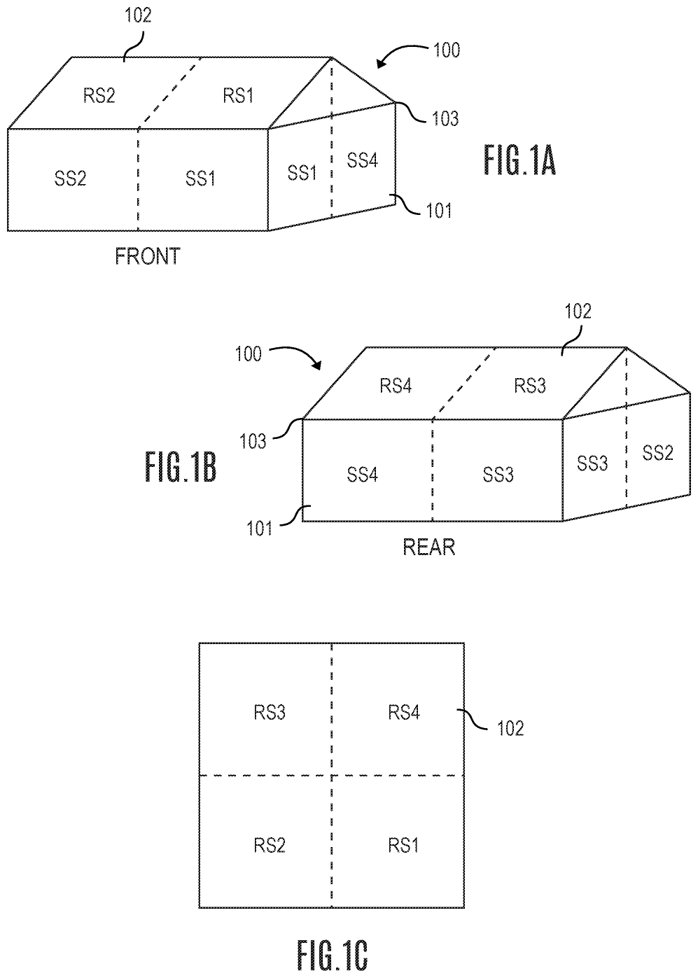

Now turning to the drawings, FIG. 1A shows a structure 100, from a front view thereof, having a roof with four roof-sections 102 and corresponding side-sections 101 extending about a periphery of the structure. The roof sections are numbered RS1, RS2 (and RS3, RS4 shown in FIG. 1B). The side sections are numbered SS1, SS2, SS4 (whereas side-sections SS2, SS3 and SS4 are shown in FIG. 1B). In this regard, roof section RS1 is vertically associated and aligned with side section SS1 in FIG. 1A. Likewise, RS2 is vertically associated and aligned with SS2; RS3 is vertically associated and aligned with SS3; and RS4 is vertically associated and aligned with SS4. Eaves 103 extend along a periphery of the structure between the side-sections and the roof-sections.

FIG. 1B shows the structure 100, from a rear view thereof, having a roof with four roof-sections 102 and corresponding side-sections 101 extending about a periphery of the structure. Eaves 103 extend about a periphery of the structure between the side-sections and roof-sections. Visible from the rear view as shown in FIG. 1B are side-sections SS2, SS3, and SS4, as well as roof-sections RS3 and RS4.

FIG. 1C shows the structure, from a top view thereof, having a roof with four roof-sections 102 each labeled as RS1, RS2, RS3, and RS4.

The structure of FIGS. 1(A-C) is shown being divided into four quadrants, each quadrant defined by a side-section and corresponding roof-section vertically aligned therewith, for example, SS1 and RS1 form a first quadrant. However, it will be recognized by one with skill in the art that a smaller structure may be divided into two side-sections and two roof-sections for covering, or that a larger structure may be divided into five or more side-sections and five or more roof-sections for covering. Additionally, in certain circumstances a structure may require more, or less, roof-sections compared to the number of side-sections required for covering. The illustrated example is provided as being divided into four quadrants for simplifying the details and inner-workings of the proposed fire protective cover. In practice, any structure may be assigned an arbitrary number of side sections and roof sections which correspond to the size of the side-cover and roof-cover portions, respectively. The invention is not intended to be limited to the illustrated example and may in fact be expanded to other embodiments utilizing more, or less, than four sections of a structure.

For clarity, each of the side-cover and roof-cover portions may independently comprise an area of eight foot by eight foot (64 square feet) up to fifty foot by fifty foot (2500 square feet), whereas the side-cover and roof-cover portions are generally rectangular but not required to be square.

Each of the side-cover portions and the roof-cover portions may independently comprise one or more fabrics from the group consisting of: wool, acrylic, polyester, nylon, Kevlar, and Nomex. In a preferred embodiment, the side-cover portions and the roof-cover portions may independently comprise oxidized polyacrylonitrile (OPAN) fiber, or a felt fabricated therefrom, such as ZOLTEK OX felt (https://zoltek.com/products/ox/). In addition, the one or more fabrics forming the side-cover and/or roof-cover portions may be treated with a fire-resistant or fire-retardant coating such as FX FabricGuard™, a dicyandiamide-containing spray, and/or others known to one having skill in the art.

The following is an example of a system including a fire protective cover in accordance with the illustrated embodiment.

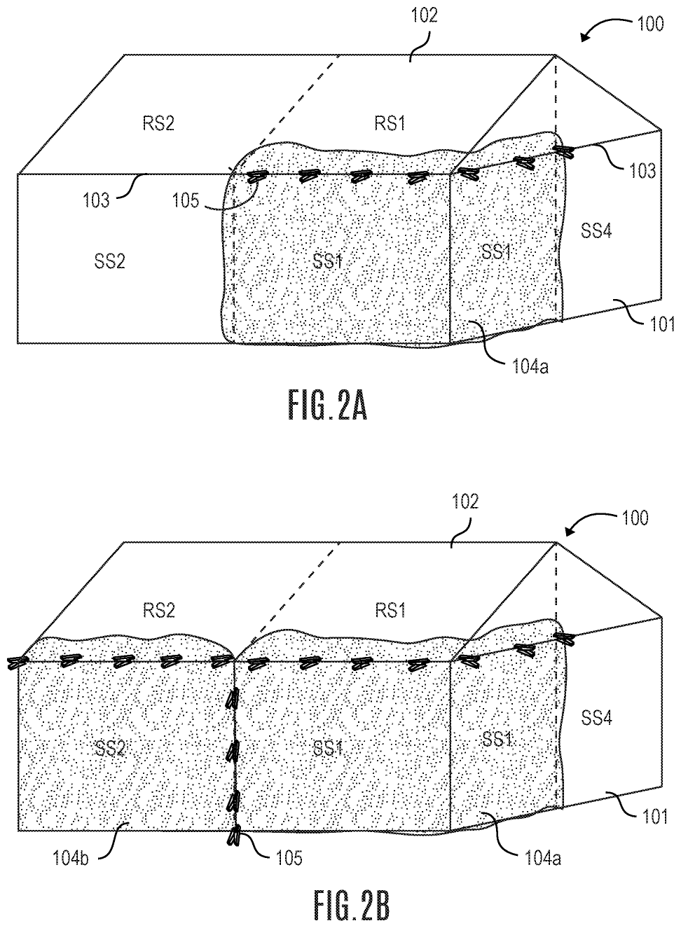

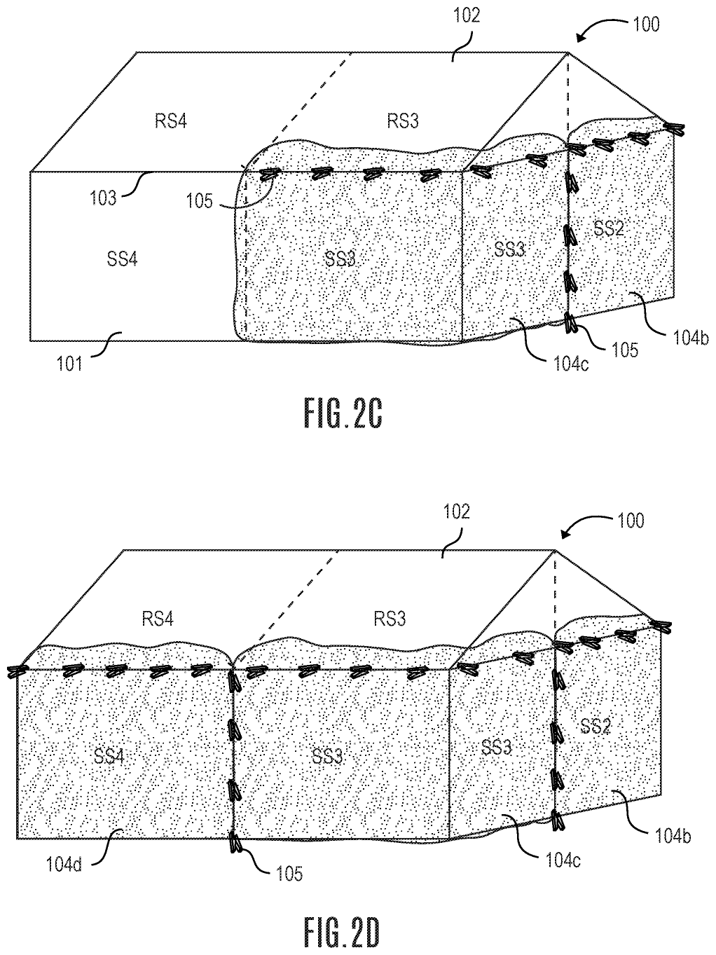

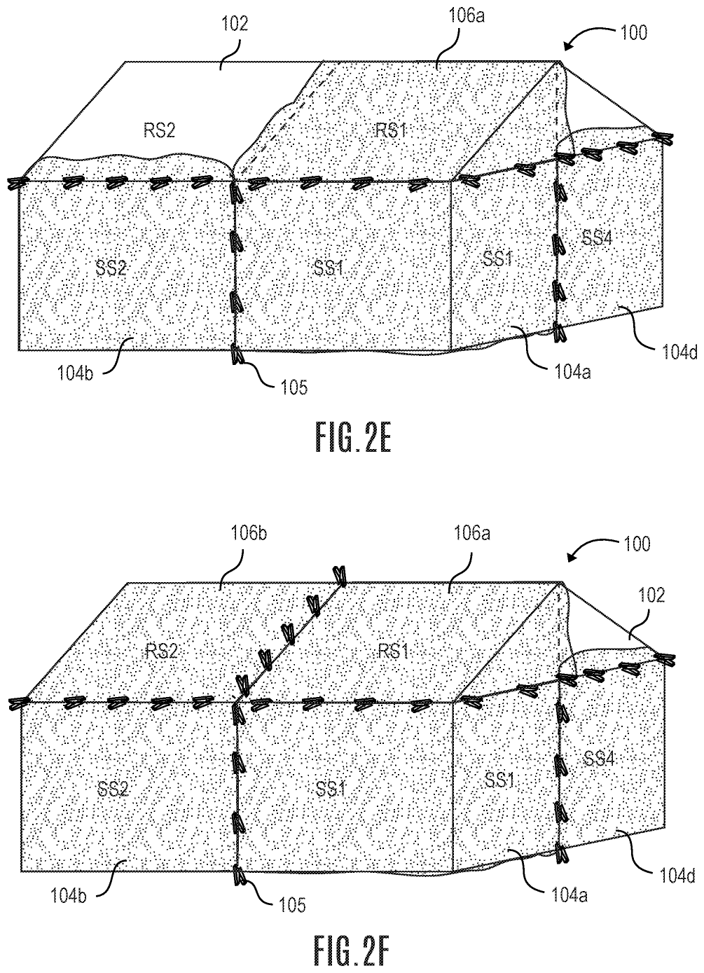

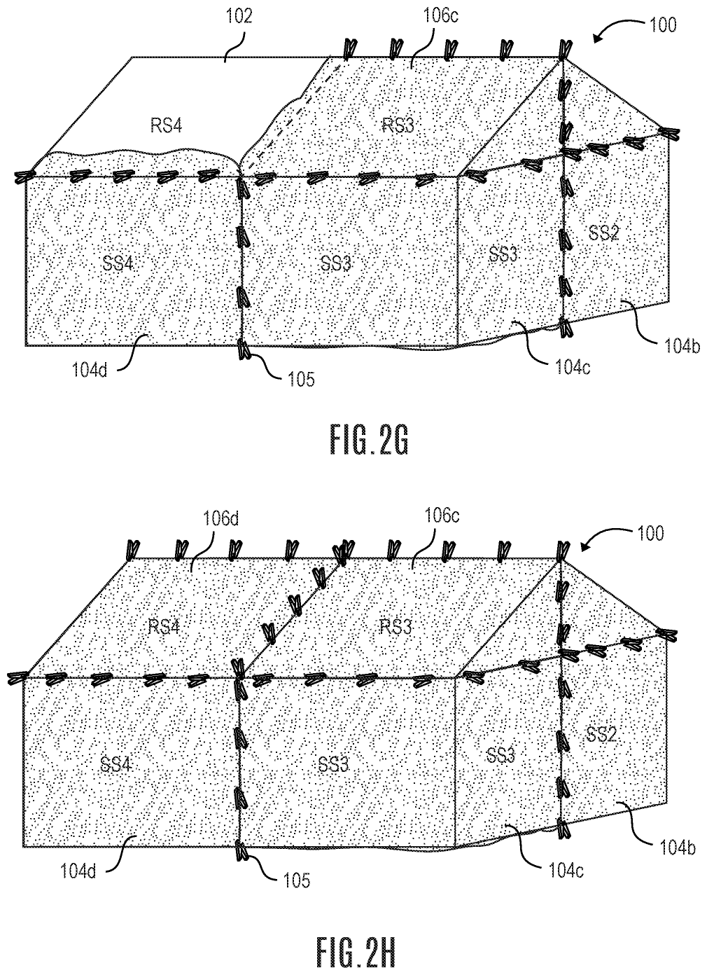

FIG. 2A shows a first step for covering the structure with a fire protective cover. Here, a first side-cover portion 104a is attached to an eave 103 of the structure 100 along a horizontal periphery via a plurality of attachment elements 105, such as clamps. The first side-cover portion is configured to cover a first side section SS1. A first roof section RS1 is disposed adjacent to the first side section as shown.

Other features of the structure are shown in FIG. 2A for comparative reference with other figures. The structure is shown from a front view in FIGS. 2(A-B).

FIG. 2B shows a second step for covering the structure with the fire protective cover. Continuing from that shown in FIG. 2A, a second side-cover portion 104b is attached to an eave 103 of the structure 100 along the horizontal periphery via a plurality of attachment elements 105. Additional attachment elements are shown, though may be optional, for connecting the first and second side-cover portions to form a vertical seam therebetween. The second side-cover portion is configured to cover a second side section SS2. A second roof section RS2 is disposed adjacent to the second side section as shown.

FIG. 2C shows a third step for covering the structure with the fire protective cover. Here, a third side-cover portion 104c is attached to an eave 103 of the structure 100 along the horizontal periphery via a plurality of attachment elements 105. Again, additional attachment elements are shown, though may be optional, for connecting the second and third side-cover portions to form a vertical seam therebetween. The third side-cover portion is configured to cover a third side section SS3. A third roof section RS3 is disposed adjacent to the third side section as shown.

FIG. 2D shows a fourth step for covering the structure with the fire protective cover. In this step, the side sections of the house become completely covered by the fire protective cover. As shown, a fourth side-cover portion 104d is attached to an eave of the structure 100 along the horizontal periphery via a plurality of attachment elements 105. Optionally, additional attachment elements may be implemented to independently connect the fourth side-cover portion to each of the first and third side-cover portions, respectively. The fourth side-cover portion is adapted to cover the fourth side section SS4 of the structure. A fourth roof section RS4 is disposed adjacent to the fourth side section as shown.

With the side sections each being covered, the next progression of the installation requires covering the roof sections 102.

FIG. 2E shows a fifth step for covering the structure with the fire protective cover. Here, a first roof-cover portion 106a is placed over the first roof section RS1, and the first roof-cover portion is attached to the eave of the house, preferably, but optionally, by reusing the same attachment elements associated with the first side-cover portion at the eave. Bean bags or other weighted objects (not shown) can be used to temporarily hold the roof-cover portions while the installation is being implemented. Portions of the first roof-cover portion may overlap or connect with the first side-cover portion along the eave of the structure.

FIG. 2F shows a sixth step for covering the structure with the fire protective cover. Here, a second roof-cover portion 106b is placed over the second roof section RS2, and the second roof-cover portion is attached to the eave of the house, preferably, but optionally, by reusing the same attachment elements associated with the second side-cover portion at the eave. Portions of the second roof-cover portion may overlap or connect with the second side-cover portion along the eave of the structure. Additional attachment elements 105 may be implemented at a connection between the first and second roof-cover portions to form a seam therebetween.

FIG. 2G shows a seventh step for covering the structure with the fire protective cover. Here, a third roof-cover portion 106c is placed over the third roof section RS3, and the third roof-cover portion is attached to the eave of the house, preferably, but optionally, by reusing the same attachment elements associated with the third side-cover portion at the eave. Portions of the third roof-cover portion may overlap or connect with the third side-cover portion along the eave of the structure. Additional attachment elements 105 may be implemented at a connection between the second and third roof-cover portions to form a seam therebetween. Moreover, further additional attachment elements 105 may be implemented at a connection between the second and third roof-cover portions along the apex of the roof as shown. In this regard, each mating of a side-cover portion and roof-cover portion, two side-cover portions, and/or two roof-cover portions may form a connective seam therebetween with a plurality of attachment elements holding two fabric portions together, respectively.

FIG. 2H shows an eighth step for covering the structure with the fire protective cover. Here, a fourth roof-cover portion 106d is placed over the fourth roof section RS4, and the fourth roof-cover portion is attached to the eave of the house, preferably, but optionally, by reusing the same attachment elements associated with the fourth side-cover portion at the eave. Portions of the fourth roof-cover portion may overlap or connect with the fourth side-cover portion along the eave of the structure. Additional attachment elements 105 may be implemented at a connection between the third and fourth roof-cover portions to form a seam therebetween. With the eight step described and illustrated in this exemplary embodiment, the entire roof of the structure is now covered.

FIG. 2I shows the structure with a fire protective cover completely installed and secured with an optional cable. In addition to each of the side-cover portions and the roof-cover portions being installed and connected to form a unitary cover for protecting the structure, an additional element including a cable 108 is provided. The cable is installed around a periphery of the structure at the side surfaces, as shown. Here, the cable is inserted through loops 107 of the fire protective cover, however the loops are optional. Two opposing ends of the cable are met at a mating element 109, which can be any mechanical element capable of receiving two ends of the cable and securely holding them together. In this regard, the cable is adapted to hold each of the side-cover portions to the side sections of the structure for improved retention in the event of strong winds.

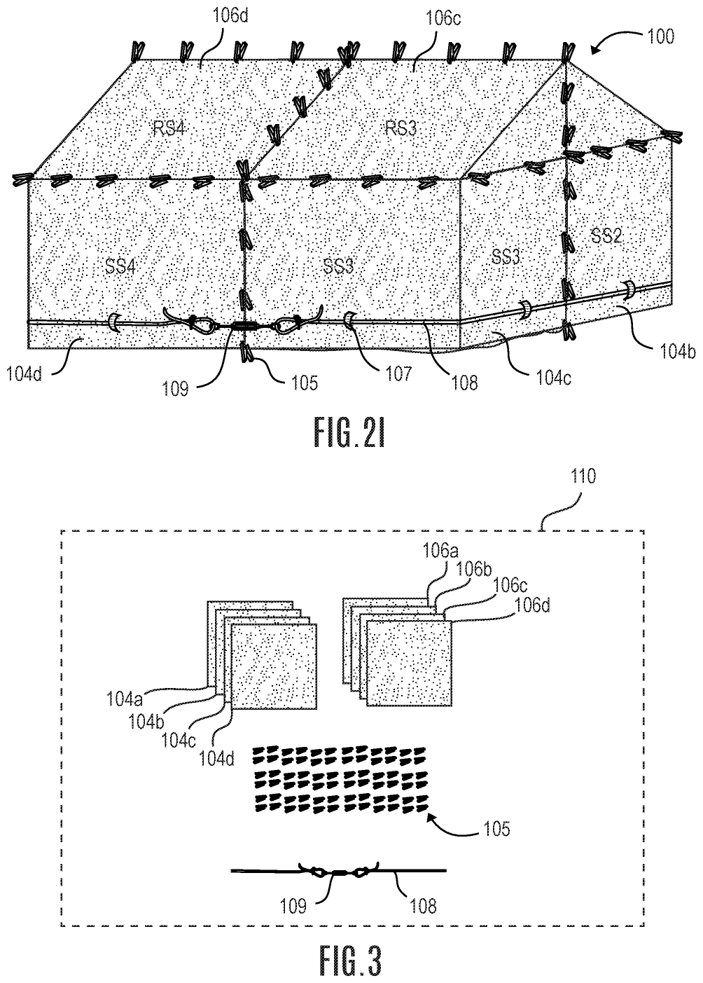

FIG. 3 shows a system 110 comprising a plurality of side-cover portions 104a; 104b; 104c; and 104d, respectively, a plurality of roof-cover portions 106a; 106b; 106c; and 106d, respectively, a plurality of attachment elements 105, and an optional cable 108 and cable-mating element 109.

One key feature of the invention is the side-cover portions are attached to eaves of the structure using attachment elements, such as, but not limited to, clamps. The side-cover portions are attached to the eaves of the structure one at a time until the entire periphery of the side of the house is covered.

Another key feature of the invention is the roof-cover portions are installed after the side-cover portions are installed. This provides overlap of the roof-cover portions at the terminal edge of the side-cover portions. The clamps holding the side-cover portions to the eaves of the structure may be reused in one or more places to also attach the adjacent roof-cover portion at the same eave.

Another key feature is the ability of a side-cover portion to be installed at a corner of the structure, as shown in the drawings. In fact, four side-cover portions may be installed at each of four corners of a rectangular structure. One or more intervening side portions may be installed between two corner-installed portions.

Yet another key feature is the cable extending about the periphery of the structure and tightly secured to hold the side-cover portions about the corresponding side-sections for which they cover.

Therefore, in one embodiment, a fire protective cover is disclosed, the fire protective cover is adapted to protect a structure in the event of an imminent fire hazard, and comprises: a first side-cover portion configured for attachment at a first side-section of the structure; a second side-cover portion configured for attachment at a second side-section of the structure; a third side-cover portion configured for attachment at a third side-section of the structure; a fourth side-cover portion configured for attachment at a fourth side-section of the structure; a first roof-cover portion configured for attachment at a first roof-section of the structure; a second roof-cover portion configured for attachment at a second roof-section of the structure; a third roof-cover portion configured for attachment at a third roof-section of the structure; and a fourth roof-cover portion configured for attachment at a fourth roof-section of the structure.

In some variations, each of the first thru fourth side-cover portions and the first thru fourth roof-cover portions can be adapted to attach with at least one eave of the structure via a plurality of attachment elements.

In a preferred embodiment, the attachment elements comprise clamps. However, other conventional attachment elements as appreciated by one having skill in the art may be similarly implemented.

In some variations, each of the first thru fourth side-cover portions can be adapted to overlap with at least one other of the first thru fourth side-cover portions.

In some variations, the fire protective cover may further comprise one or more loops for receiving a cable, the cable configured to extend about a periphery of the structure for securing each of the side-cover portions with side surfaces of the structure.

In another aspect, a system for protecting a structure in the event of an imminent fire hazard is disclosed, the system comprises: a fire protective cover comprising a plurality of cover portions; a plurality of attachment elements for securing the cover portions of the fire protective cover to eaves of the structure; and a cable configured to extend about a periphery of the structure for securing each of the cover portions therewith.

In some variations, the fire protective cover comprises: a first side-cover portion configured for attachment at a first side-section of the structure; a second side-cover portion configured for attachment at a second side-section of the structure; a third side-cover portion configured for attachment at a third side-section of the structure; a fourth side-cover portion configured for attachment at a fourth side-section of the structure; a first roof-cover portion configured for attachment at a first roof-section of the structure; a second roof-cover portion configured for attachment at a second roof-section of the structure; a third roof-cover portion configured for attachment at a third roof-section of the structure; and a fourth roof-cover portion configured for attachment at a fourth roof-section of the structure.

In a preferred embodiment, the attachment elements of the system comprise clamps.

In yet another aspect, a method for installing a system for protecting a structure in the event of an imminent fire hazard is disclosed, the method comprises: (i) providing a system comprising: a fire protective cover including a plurality of cover portions, a plurality of clamps for securing the cover portions of the fire protective cover to eaves of the structure, and a cable configured to extend about a periphery of the structure for securing each of the cover portions therewith; (ii) attaching a first side-cover portion of the fire protective cover to an eave of the structure using a plurality of attachment elements such that the first side-cover portion is draped over a first side-section of the structure; (iii) attaching a second side-cover portion of the fire protective cover to an eave of the structure using a plurality of attachment elements such that the second side-cover portion is draped over a second side-section of the structure; (iv) attaching a third side-cover portion of the fire protective cover to an eave of the structure using a plurality of attachment elements such that the third side-cover portion is draped over a third side-section of the structure; (v) attaching a fourth side-cover portion of the fire protective cover to an eave of the structure using a plurality of attachment elements such that the fourth side-cover portion is draped over a fourth side-section of the structure; (vi) attaching a first roof-cover portion of the fire protective cover to an eave of the structure using a plurality of attachment elements such that the first roof-cover portion is adapted to cover a first roof-section of the structure and wherein the first roof-cover portion is further adapted to overlap at least a portion of the first side-cover portion; (vii) attaching a second roof-cover portion of the fire protective cover to an eave of the structure using a plurality of attachment elements such that the second roof-cover portion is adapted to cover a second roof-section of the structure and wherein the second roof-cover portion is further adapted to overlap at least a portion of the second side-cover portion; (viii) attaching a third roof-cover portion of the fire protective cover to an eave of the structure using a plurality of attachment elements such that the third roof-cover portion is adapted to cover a third roof-section of the structure and wherein the third roof-cover portion is further adapted to overlap at least a portion of the third side-cover portion; (ix) attaching a fourth roof-cover portion of the fire protective cover to an eave of the structure using a plurality of attachment elements such that the first roof-cover portion is adapted to cover a fourth roof-section of the structure and wherein the fourth roof-cover portion is further adapted to overlap at least a portion of the fourth side-cover portion; and (x) securing a cable about a periphery of the structure for securing each of the cover portions about the structure.

In a preferred embodiment, the plurality of attachment elements comprises clamps.

While various details, features, and combinations are described in the illustrated embodiments, one having skill in the art will appreciate a myriad of possible alternative combinations and arrangements of the features disclosed herein. As such, the descriptions are intended to be enabling only, and non-limiting. Instead, the spirit and scope of the invention is set forth in the appended claims.

### FEATURE LIST

structure (100)
side-sections (101)
roof-sections (102)
eaves (103)
side-cover portions (104a; 104b; 104c; 104d)
attachment elements (105)
roof-cover portions (106a; 106b; 106c; 106d)
loop (107)
cable (108)
cable-mating element (109)
system (110)

1. A fire protective cover adapted to protect a structure in the event of an imminent fire hazard, the fire protective cover comprising:
a first side-cover portion configured for attachment at a first side-section of the structure;
a second side-cover portion configured for attachment at a second side-section of the structure;
a third side-cover portion configured for attachment at a third side-section of the structure;
a fourth side-cover portion configured for attachment at a fourth side-section of the structure;
a first roof-cover portion configured for attachment at a first roof-section of the structure;
a second roof-cover portion configured for attachment at a second roof-section of the structure;
a third roof-cover portion configured for attachment at a third roof-section of the structure; and
a fourth roof-cover portion configured for attachment at a fourth roof-section of the structure.

2. The fire protective cover of claim 1, wherein each of the first thru fourth side-cover portions and the first thru fourth roof-cover portions is adapted to attach with at least one eave of the structure via a plurality of attachment elements.

3. The fire protective cover of claim 2, wherein the attachment elements comprise clamps.

4. The fire protective cover of claim 1, wherein each of the first thru fourth side-cover portions is adapted to overlap with at least one other of the first thru fourth side-cover portions.

5. The fire protective cover of claim 1, further comprising one or more loops for receiving a cable, the cable configured to extend about a periphery of the structure for securing each of the cover portions therewith.

6. A system for protecting a structure in the event of an imminent fire hazard, the system comprising:
a fire protective cover comprising a plurality of cover portions;
a plurality of attachment elements for securing the cover portions of the fire protective cover to eaves of the structure; and
a cable configured to extend about a periphery of the structure for securing each of the cover portions therewith.

7. The system of claim 6, said fire protective cover comprising:
a first side-cover portion configured for attachment at a first side-section of the structure;
a second side-cover portion configured for attachment at a second side-section of the structure;
a third side-cover portion configured for attachment at a third side-section of the structure;
a fourth side-cover portion configured for attachment at a fourth side-section of the structure;
a first roof-cover portion configured for attachment at a first roof-section of the structure;
a second roof-cover portion configured for attachment at a second roof-section of the structure;
a third roof-cover portion configured for attachment at a third roof-section of the structure; and
a fourth roof-cover portion configured for attachment at a fourth roof-section of the structure.

8. The system of claim 6, wherein the attachment elements comprise clamps.

9. A method for installing a system for protecting a structure in the event of an imminent fire hazard, the method comprising:
providing a system comprising:
a fire protective cover including a plurality of cover portions,
a plurality of clamps for securing the cover portions of the fire protective cover to eaves of the structure, and
a cable configured to extend about a periphery of the structure for securing each of the cover portions therewith;
attaching a first side-cover portion of the fire protective cover to an eave of the structure using a plurality of attachment elements such that the first side-cover portion is draped over a first side-section of the structure;
attaching a second side-cover portion of the fire protective cover to an eave of the structure using a plurality of attachment elements such that the second side-cover portion is draped over a second side-section of the structure;
attaching a third side-cover portion of the fire protective cover to an eave of the structure using a plurality of attachment elements such that the third side-cover portion is draped over a third side-section of the structure;
attaching a fourth side-cover portion of the fire protective cover to an eave of the structure using a plurality of attachment elements such that the fourth side-cover portion is draped over a fourth side-section of the structure;
attaching a first roof-cover portion of the fire protective cover to an eave of the structure using a plurality of attachment elements such that the first roof-cover portion is adapted to cover a first roof-section of the structure and wherein the first roof-cover portion is further adapted to overlap at least a portion of the first side-cover portion;
attaching a second roof-cover portion of the fire protective cover to an eave of the structure using a plurality of attachment elements such that the second roof-cover portion is adapted to cover a second roof-section of the structure and wherein the second roof-cover portion is further adapted to overlap at least a portion of the second side-cover portion;
attaching a third roof-cover portion of the fire protective cover to an eave of the structure using a plurality of attachment elements such that the third roof-cover portion is adapted to cover a third roof-section of the structure and wherein the third roof-cover portion is further adapted to overlap at least a portion of the third side-cover portion;
attaching a fourth roof-cover portion of the fire protective cover to an eave of the structure using a plurality of attachment elements such that the first roof-cover portion is adapted to cover a fourth roof-section of the structure and wherein the fourth roof-cover portion is further adapted to overlap at least a portion of the fourth side-cover portion; and
securing a cable about a periphery of the structure for securing each of the cover portions about the structure.

10. The method of claim 9, wherein said plurality of attachment elements comprises clamps.
